(19) United States
(12) Patent Application Publication
(10) Pub. No.: US 2019/0258486 A1
(43) Pub. Date: Aug. 22, 2019

(54) EVENT-BASED BRANCHING FOR SERIAL PROTOCOL PROCESSOR-BASED DEVICES

(71) Applicant: QUALCOMM Incorporated, San Diego, CA (US)

(72) Inventors: Oren Nishry, Bet Lham HaGlilit (IL); Tomer Rafael Ben-Chen, Amikam (IL); Sharon Graif, Zichron Yaakov (IL); Felix Kolmakov, Netanya (IL)

(21) Appl. No.: 16/281,290

(22) Filed: Feb. 21, 2019

Related U.S. Application Data
(60) Provisional application No. 62/633,127, filed on Feb. 21, 2018.

(51) Int. Cl. G06F 9/30; G06F 9/35

(52) U.S. Cl. CPC G06F 9/30058; G06F 9/35

(57) ABSTRACT

Event-based branching for serial protocol processor-based devices is disclosed. In this regard, a serial protocol processor-based device provides an event mesh control circuit comprising a mapping table circuit and a register control array corresponding to rows of the mapping table circuit. Each row of the mapping table circuit of the event mesh control circuit represents an implementation-specific grouping of events, with each column of the row representing a last known status or outcome for a corresponding event. A microcontroller of the serial protocol processor-based device is configured to use the register control array to select which event (i.e., which column of a corresponding row) will be used to make a branching determination. A branch custom instruction provided by the microcontroller indicates a selected row, a branch target address, and a comparison value to compare against the event indicated by the register control array entry corresponding to the selected row.

### PRIORITY

The present application claims priority under 35 U.S.C. § 119(e) to U.S. Provisional Patent Application Ser. No. 62/633,127 filed Feb. 21, 2018 entitled “PROVIDING EVENT-BASED BRANCHING FOR SERIAL PROTOCOL PROCESSOR-BASED DEVICES,” the contents of which is incorporated herein by reference in its entirety.

### BACKGROUND

### I. Field of the Disclosure

The technology of the disclosure relates generally to serial protocol processing in processor-based devices, and, in particular, to implementing branching in serial protocol processor-based devices.

### II. Background

Conventional processor-based devices, such as central processing units (CPUs), provide a number of mechanisms for implementing branching (i.e., determining when and how to cause the processor-based device to deviate from its default behavior of executing computer program instructions in program order, and instead begin executing a different instruction sequence). For instance, in processor-based devices based on the INTEL® x86 architecture, branching may be based on arithmetic logic unit (ALU) flags, which may be set by the results of an ALU operation and which subsequently may be used to determine if a branch should be taken. Similarly, processor-based devices based on the Microprocessor without Interlocked Pipeline Stages (MIPS®) architecture may implement branching using register comparison, where an instruction compares one register to another register (or an immediate value) and the result is used to determine if a branch should be taken.

However, branching based on ALU flags and/or register comparisons may be inefficient for certain applications. In particular, processor-based devices such as microcontrollers for serial protocol processing (e.g., processors configured to operate according to the Serial Peripheral Interface (SPI) or the Inter-Integrated Circuit (I²C) protocols) may be required to compare many different status flags, set by multiple events (i.e., changes to the internal status of one or more constituent elements of the processor-based device), to determine whether branching should take place. Using conventional branching mechanisms for serial protocol processing may require multiple instructions, executing over multiple processor cycles, for each branch. For instance, branching based on ALU flags that are set by a CMP (compare) instruction would require the following three (3) instructions for each potential branch:

mov $1, address//Read event status by moving event status value from “address” to a location specified by “$1”;

cmp $1, #value//Compare the value stored at “$1” to an arbitrary immediate value “#value”; and

beq address//Branch if value stored at “$1” and “#value” are equal

For serial protocol processor-based devices that must evaluate the outcome of multiple events to determine if a branch should be taken, the number of instructions and processor cycles required may make such a determination inefficient or impracticable. Accordingly, it is desirable to provide an improved mechanism for implementing branching in serial protocol processor-based devices.

### SUMMARY OF THE DISCLOSURE

Aspects disclosed in the detailed description include event-based branching for serial protocol processor-based devices. In this regard, in some exemplary aspects, a serial protocol processor-based device provides an event mesh control circuit comprising a two-dimensional (2D) mapping table circuit. Each row of the mapping table circuit represents an implementation-specific grouping of events, with each column within the row configured to store a value (referred to herein as an “event indicator”) that represents a last known status or outcome for an event corresponding to that column and row. The event mesh control circuit further includes a register control array having entries corresponding to the rows of the mapping table circuit, with each entry in the register control array storing a selected column value indicating which event indicator within the corresponding row is to be used for branching determinations. A microcontroller of the serial protocol processor-based device supports a custom branch instruction that specifies as operands a selected row indicator, a branch target address, and a comparison value. Upon execution of the custom branch instruction by the microcontroller, the event mesh control circuit compares the comparison value against the event indicator that is indicated by the selected column value of the entry of the register control array that corresponds to the selected row indicator. The event mesh control circuit then returns a branch indicator to the microcontroller to indicate whether or not a branch to the branch target address should be performed. By employing the custom branch instruction in conjunction with the event mesh control circuit, serial protocol processor-based devices may perform event-based branching operations more efficiently by using fewer individual instructions and fewer processor cycles compared to the conventional techniques discussed above. In some exemplary aspects, the serial protocol processor-based device also provides a mask indicator array corresponding to the rows of the mapping table circuit. The mask indicator array allows multiple individual event indicators to be aggregated into a single “composite event indicator” that may be used to make branching determinations. This enables serial protocol processor-based devices to make branching determinations based on multiple event indicators even more efficiently.

In another exemplary aspect, a serial protocol processor-based device for supporting event-based branching is provided. The serial protocol processor-based device comprises a microcontroller configured to execute a plurality of program instructions, and an event mesh control circuit communicatively coupled to the microcontroller. The event mesh control circuit comprises a mapping table circuit comprising a plurality of rows, each row of the plurality of rows comprising a plurality of columns storing a corresponding plurality of event indicators. The event mesh control circuit also comprises a register control array comprising a plurality of entries corresponding to the plurality of rows of the mapping table circuit, each entry of the plurality of entries storing a selected column value indicating a selected column of the plurality of columns of a corresponding row of the plurality of rows. The event mesh control circuit is configured to receive, from the microcontroller, a selected row indicator and a comparison value. The event mesh control circuit is further configured to identify a selected column based on a selected column value of an entry of the plurality of entries of the register control array indicated by the selected row indicator. The event mesh control circuit is also configured to retrieve, from the mapping table circuit, an event indicator stored in the selected column of a row of the plurality of rows indicated by the selected row indicator. The event mesh control circuit is additionally configured to generate a branch indicator based on a comparison of the comparison value and the event indicator. The event mesh control circuit is further configured to provide the branch indicator to the microcontroller.

In another exemplary aspect, a method for supporting event-based branching is provided. The method comprises receiving, by an event mesh control circuit of a serial protocol processor-based device from a microcontroller of the serial protocol processor-based device, a selected row indicator and a comparison value, wherein the event mesh control circuit comprises a mapping table circuit comprising a plurality of rows, each row of the plurality of rows comprising a plurality of columns storing a corresponding plurality of event indicators, and a register control array comprising a plurality of entries corresponding to the plurality of rows of the mapping table circuit, each entry of the plurality of entries storing a selected column value indicating a selected column of the plurality of columns of a corresponding row of the plurality of rows. The method further comprises identifying a selected column based on a selected column value of an entry of the plurality of entries of the register control array indicated by the selected row indicator. The method also comprises retrieving, from the mapping table circuit, an event indicator stored in the selected column of a row of the plurality of rows of the mapping table circuit indicated by the selected row indicator. The method additionally comprises generating a branch indicator based on a comparison of the comparison value and the event indicator. The method further comprises providing the branch indicator to the microcontroller.

In another exemplary aspect, a serial protocol processor-based device for supporting event-based branching is provided. The serial protocol processor-based device comprises a means for receiving a selected row indicator and a comparison value. The serial protocol processor-based device further comprises a means for identifying a selected column of a mapping table circuit based on a selected column value of an entry of a plurality of entries of a register control array indicated by the selected row indicator, wherein the mapping table circuit comprises a plurality of rows, each row of the plurality of rows comprising a plurality of columns storing a corresponding plurality of event indicators, and the register control array comprises a plurality of entries corresponding to the plurality of rows of the mapping table circuit, each entry of the plurality of entries storing a selected column value indicating a selected column of the plurality of columns of a corresponding row of the plurality of rows. The serial protocol processor-based device also comprises a means for retrieving, from the mapping table circuit, an event indicator stored in the selected column of a row of the plurality of rows of the mapping table circuit indicated by the selected row indicator. The serial protocol processor-based device additionally comprises a means for generating a branch indicator based on a comparison of the comparison value and the event indicator.

### BRIEF DESCRIPTION OF THE FIGURES

FIG. 1 is a block diagram of an exemplary serial protocol processor-based device supporting event-based branching for serial protocol processing;

FIG. 2 is a block diagram illustrating a more detailed exemplary view of an event mesh control circuit of the serial protocol processor-based device of FIG. 1;

FIG. 3 is a block diagram illustrating contents of an exemplary event mesh control circuit according to one aspect;

FIGS. 4A and 4B are flowcharts illustrating exemplary operations for event-based branching for serial protocol processing by the serial protocol processor-based device of FIG. 1 in some aspects; and

FIG. 5 is a block diagram of an exemplary processor-based system that may include the serial protocol processor-based device and the event mesh control circuit of FIGS. 1 and 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

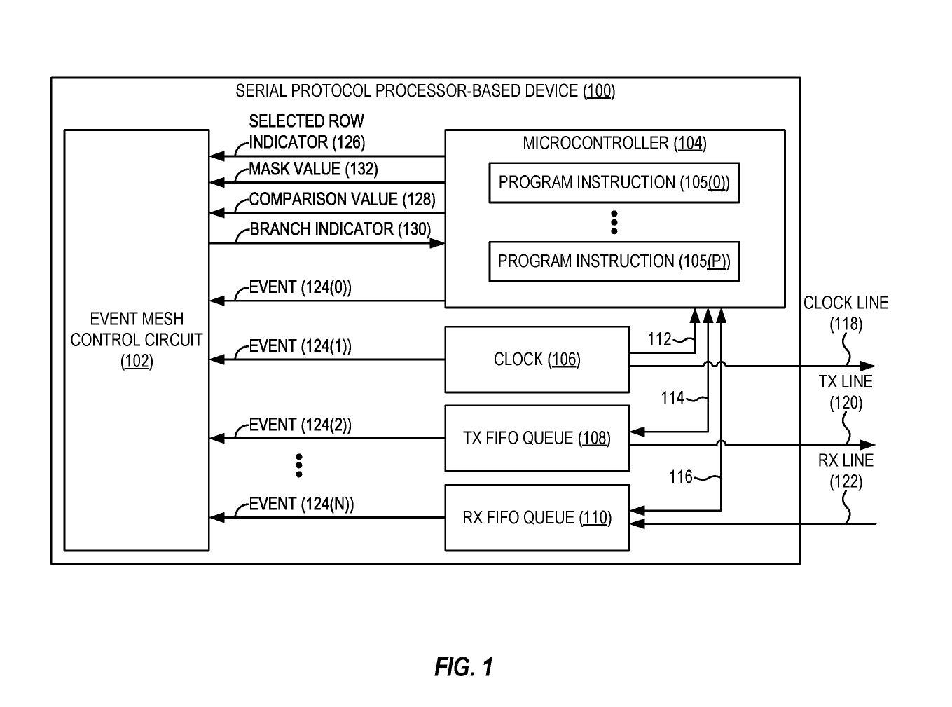

Aspects disclosed in the detailed description include event-based branching in serial protocol processor-based devices. In this regard, FIG. 1 illustrates a serial protocol processor-based device 100 that includes an event mesh control circuit 102 configured to enable efficient event-based branching. The serial protocol processor-based device 100, according to some aspects, may be configured to process data according to the Serial Peripheral Interface (SPI) or the Inter-Integrated Circuit (I²C) protocols, as non-limiting examples. Accordingly, in the example of FIG. 1, the serial protocol processor-based device 100 provides a microcontroller 104 for executing program instructions 105(0)-105(P). The microcontroller 104 is communicatively coupled to a clock 106, a transmit first-in-first-out queue (“TX FIFO QUEUE”) 108, and a receive first-in-first-out queue (“RX FIFO QUEUE”) 110, as indicated by arrows 112, 114, and 116, respectively. The microcontroller 104 in some aspects may comprise one or more central processing units (CPUs) or processor cores, memory devices, and/or input/output (I/O) interfaces as known in the art, and which are not shown in FIG. 1 for the sake of clarity. The microcontroller 104 receives a clock signal (e.g., as indicated by arrow 112) from the clock 106, which in some aspects may also provide the clock signal to other devices external to the serial protocol processor-based device 100 via a clock line 118. The TX FIFO queue 108 is operative to buffer data received from the microcontroller 104 for transmission to other devices via a transmit line (“TX LINE”) 120. Similarly, the RX FIFO queue 110 is configured to buffer data received from other devices via a receive line (“RX LINE”) 122. In some aspects, the TX FIFO queue 108 and/or the RX FIFO queue 110 may be implemented as a plurality of registers.

It is to be understood that some aspects of the serial protocol processor-based device 100 may include more or fewer data transmission lines than the TX line 120 and the RX line 122 illustrated in FIG. 1, according to the requirements of the serial protocol implemented by the serial protocol processor-based device 100. As non-limiting examples, some aspects of the serial protocol processor-based device 100 may provide a single bidirectional data transmission line in place of unidirectional data transmission lines such as the TX line 120 and the RX line 122. In some aspects, the serial protocol processor-based device 100 may provide multiple TX lines 120 and/or multiple RX lines 122, and/or may provide additional circuitry such as a slave device selection line. It is to be further understood that, although the event mesh control circuit 102 is illustrated as an element separate from the microcontroller 104, some aspects may provide that the event mesh control circuit 102 is integrated into the microcontroller 104. Moreover, it is to be understood that the serial protocol processor-based device 100 of FIG. 1 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor sockets or packages. It is to be understood that some aspects of the serial protocol processor-based device 100 may include elements in addition to those illustrated in FIG. 1.

In the example of FIG. 1, the microcontroller 104, the clock 106, the TX FIFO queue 108, and the RX FIFO queue 110 generate corresponding events 124(0)-124(N) during normal operation. Each of the events 124(0)-124(N) comprises a value (e.g., a signal, as a non-limiting example) that corresponds to and indicates one or more changes to the internal status of the microcontroller 104, the clock 106, the TX FIFO queue 108, and/or the RX FIFO queue 110, respectively, or the constituent elements thereof. For instance, data operations performed on the TX FIFO queue 108 may generate the event 124(2), which may comprise a value indicating that data has been pushed into the TX FIFO queue 108, data has been popped from the TX FIFO queue 108, the TX FIFO queue 108 is empty, and/or the TX FIFO queue 108 is full, as non-limiting examples. Likewise, the microcontroller 104 may generate the event 124(0) to indicate the results of a parity or cyclic redundancy check, the state of an internal flag, or a reaction by the microcontroller 104 to a line status or an internal counter status, as non-limiting examples. It is to be understood that, while the example shown in FIG. 1 illustrates a total of four (4) events 124(0)-124(N), some aspects may provide more or fewer events than shown in FIG. 1, and each element of the serial protocol processor-based device 100 may individually generate more or fewer events than shown in FIG. 1.

In some aspects, it may be desirable for the microcontroller 104, in the course of executing the program instructions 105(0)-105(P), to implement branching (i.e., a conditional transfer of program control) based on one or more of the events 124(0)-124(N). However, as noted above, conventional mechanisms for implementing branching may be inefficient or impracticable in the context of serial protocol processing, due to the number of instructions and processor cycles that may be required to evaluate the outcome of multiple events 124(0)-124(N) to determine if a branch should be taken. Accordingly, it is desirable to provide an improved mechanism for implementing branching in serial protocol processor-based devices such as the serial protocol processor-based device 100 of FIG. 1.

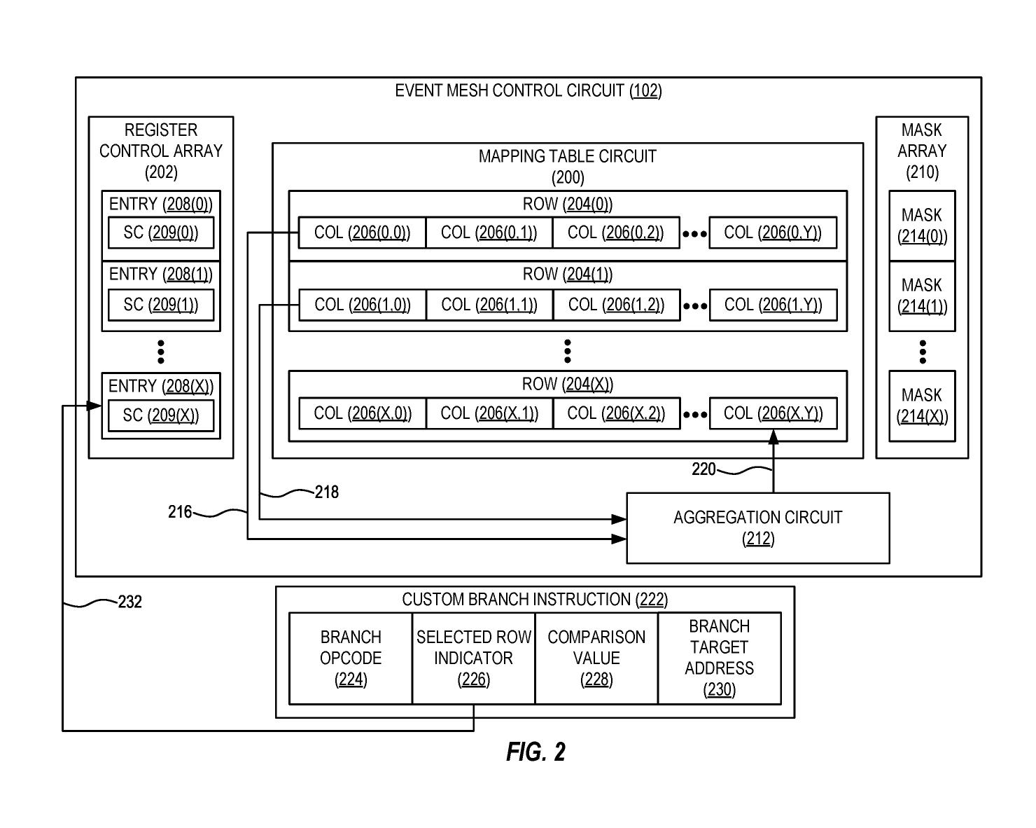

In this regard, the serial protocol processor-based device 100 in this example includes the event mesh control circuit 102 for implementing event-based branching. As discussed in more detail below with respect to FIG. 2, the event mesh control circuit 102 in this example includes a two-dimensional (2D) mapping table circuit in which each row represents an arbitrary group of events, while each column of each row stores an event indicator that represents a last known status or outcome for a corresponding event. It is to be understood that the terms “row” and “column” as used herein refer to subsections of a mapping-information array that may be stored in the 2D mapping table format described herein, but the terms “row” and “column” are not limited to any particular type of subsection. Each of the events 124(0)-124(N) is supplied to a corresponding row and column of the mapping table circuit of the event mesh control circuit 102, where the value representing the last known status or outcome of the event 124(0)-124(N) is stored as an event indicator. In some aspects, each event indicator may be a Boolean value (i.e., a value representing true or false), or may be an integer or floating-point number (e.g., a current value of a counter), as non-limiting examples.

The microcontroller 104 is configured to perform event-based branching using the event mesh control circuit 102 by providing (e.g., as part of a custom branch instruction, as a non-limiting example) a selected row indicator 126 and a comparison value 128 to the event mesh control circuit 102. The selected row indicator 126 indicates which row of the mapping table circuit of the event mesh control circuit 102 contains the column corresponding to the event 124(0)-124(N) that will be used to determine whether to branch. The event mesh control circuit 102 compares the event indicator stored in the column to the comparison value 128, and returns a branch indicator 130 to the microcontroller 104 to indicate whether the comparison of the comparison value 128 and the event indicator results in a logical value of true. Based on the value of the branch indicator 130, the microcontroller 104 then either performs a branch, or continues executing the program instruction 105(0)-105(P) in conventional program order. As discussed in greater detail with respect to FIG. 2, the microcontroller 104 may also provide a mask value 132 to the event mesh control circuit 102. The mask value 132 may be used to select multiple rows of the mapping table circuit of the event mesh control circuit 102 to be aggregated into a “composite event,” allowing the microcontroller 104 to base branching determinations on the outcome of a plurality of the events 124(0)-124(N).

To illustrate the constituent elements of and exemplary operations performed by the event mesh control circuit 102 in greater detail, FIG. 2 is provided. As seen in FIG. 2, the event mesh control circuit 102 of FIG. 1 provides a mapping table circuit 200 and a register control array 202. The mapping table circuit 200 includes a plurality of rows 204(0)-204(X), with each row 204(0), 204(1), 204(X) providing a corresponding plurality of columns 206(0,0)-206(0,Y), 206(1,0)-206(1,Y), 206(X,0)-206(X,Y). Each of the columns 206(0,0)-206(X,Y) corresponds to an event (such as the events 124(0)-124(N) of FIG. 1) generated by elements of the serial protocol processor-based device 100 of FIG. 1, and stores an event indicator (not shown) representing a last known status or outcome of the corresponding event. The register control array 202 of FIG. 2 provides a plurality of entries 208(0)-208(X), each of which corresponds to a row of the plurality of rows 204(0)-204(X) and stores a selected column value (“SC”) 209(0)-209)X). Each of the selected column values 209(0)-209(X) stored in the entries 208(0)-208(X) indicates which column 206(0,0)-206(X,Y) of the row 204(0)-204(X) corresponding to the entry 208(0)-208(X) will provide an event indicator for use in event-based branching. Thus, only one column 206(0,0)-206(X,Y) within one of the rows 204(0)-204(X) can be selected at a time. The selected column values 209(0)-209(X) may be updated by the event mesh control circuit 102 and/or the microcontroller 104 to select different columns 206(0,0)-206(X,Y) of the rows 204(0)-204(X) for event-based branching.

To enable multiple events to be evaluated when performing event-based branching, the event mesh control circuit 102 further provides a mask array 210 and an aggregation circuit 212. The mask array 210 comprises a plurality of masks 214(0)-214(X) that correspond to the plurality of rows 204(0)-204(X), and that may be used to select two or more of the plurality of rows 204(0)-204(X) containing events to be aggregated into a composite event. As a non-limiting example, each of the masks 214(0)-214(X) may either be set to zero (0) to indicate that the event contained in the corresponding row 204(0)-204(X) will not be aggregated into the composite event, or may be set to one (1) to indicate that the event contained in the corresponding row 204(0)-204(X) is to be aggregated into the composite event. In some aspects, the masks 214(0)-214(X) may be configured by the event mesh control circuit 102 and/or the microcontroller 104 using the mask value 132. For example, upon receiving the mask value 132, the event mesh control circuit 102 may set each of the masks 214(0)-214(X) to a value of a corresponding bit of the mask value 132.

The event indicators from the rows 204(0)-204(X) selected by the mask array 210 are then aggregated into a single composite event indicator by the aggregation circuit 212. In some aspects, the aggregation circuit 212 may be configured to generate the composite event indicator by comparing the event indicators from each column 206(0,0)-206(X,Y) indicated by the selected column values 209(0)-209(X) of the rows 204(0)-204(X) selected by the mask array 210 using any conventional logical or comparison operators. The result is then stored as a composite event indicator in a column of the columns 206(0,0)-206(X,Y) of the mapping table circuit 200 by the aggregation circuit 212. In some aspects, a composite event indicator cannot be used as an input into another composite event. Thus, in such aspects, any row 204(0)-204(X) containing a composite event indicator must be masked off by the mask array 210 to prevent its inclusion when generating a composite event.

To illustrate aggregation of a composite event in the example of FIG. 2, assume that the entries 208(0), 208(1), and 208(X) of the register control array 202 are set with selected column values 209(0), 209(1), and 209(X) to select the columns 206(0,0), 206(1,0), and 206(X,Y), respectively, to provide event indicators for event-based branching. Additionally, the masks 214(0) and 214(1) are set to a value of one (1), while the mask 214(X) is set to a value of zero (0). In this example, the aggregation circuit 212 receives the event indicators from columns 206(0,0) and 206(1,0) as indicated by arrows 216 and 218, respectively. The aggregation circuit 212 then performs an aggregation operation, and stores the result as a composite event in column 206(X,Y) as indicated by arrow 220.

FIG. 2 further illustrates an exemplary custom branch instruction 222 that may be provided and executed by the microcontroller 104 of FIG. 1 to perform event-based branching. The custom branch instruction 222 comprises a branch opcode 224, which is an implementation-specific machine language value specifying the event-based branch operation to be performed. The custom branch instruction 222 further includes, as operands, a selected row indicator 226, a comparison value 228, and a branch target address 230. The selected row indicator 226 corresponds to the selected row indicator 126 of FIG. 1, and specifies an entry of the entries 208(0)-208(X) of the register control array 202 from which to read a selected column value 209(0)-209(X). Because the entries 208(0)-208(X) themselves indicate which column 206(0,0)-206(X,Y) of the corresponding row 204(0)-204(X) will provide an event indicator for use in event-based branching, the selected row indicator 226 effectively selects the event indicator that will be compared to determine the branch outcome. The comparison value 228 of FIG. 2 corresponds to the comparison value 128 of FIG. 1, and is compared by the event mesh control circuit 102 to the selected event indicator to generate the branch indicator 130 of FIG. 1. Finally, the branch target address 230 of the custom branch instruction 222 specifies the address of the target instruction to which the microcontroller 104 will branch if the comparison of the selected event indicator and the comparison value 228 evaluates to a logical value of true.

Thus, in exemplary operation, the custom branch instruction 222 may provide a selected row indicator 226 that selects the entry 208(X) of the register control array 202, as indicated by arrow 232. Assuming that the entry 208(X) indicates that the event indicator stored in the column 206(X,Y) (i.e., the composite event discussed in greater detail above) is to be used for event-based branching, the event mesh control circuit 102 performs a comparison of the comparison value 228 supplied by the custom branch instruction 222 with the event indicator stored in the column 206(X,Y). If the comparison results in a logical value of true, then the event mesh control circuit 102 returns the branch indicator 130 of FIG. 1 to the microcontroller 104 indicating that the branch should be taken, and the microcontroller 104 then branches to the branch target address 230 specified by the custom branch instruction 222 (e.g., by setting a program counter to the value of the branch target address 230). If the comparison results in a logical value of false, then the event mesh control circuit 102 returns the branch indicator 130 to the microcontroller 104 indicating that the branch should not be taken, and the microcontroller 104 continues processing the program instructions 105(0)-105(P) in program order.

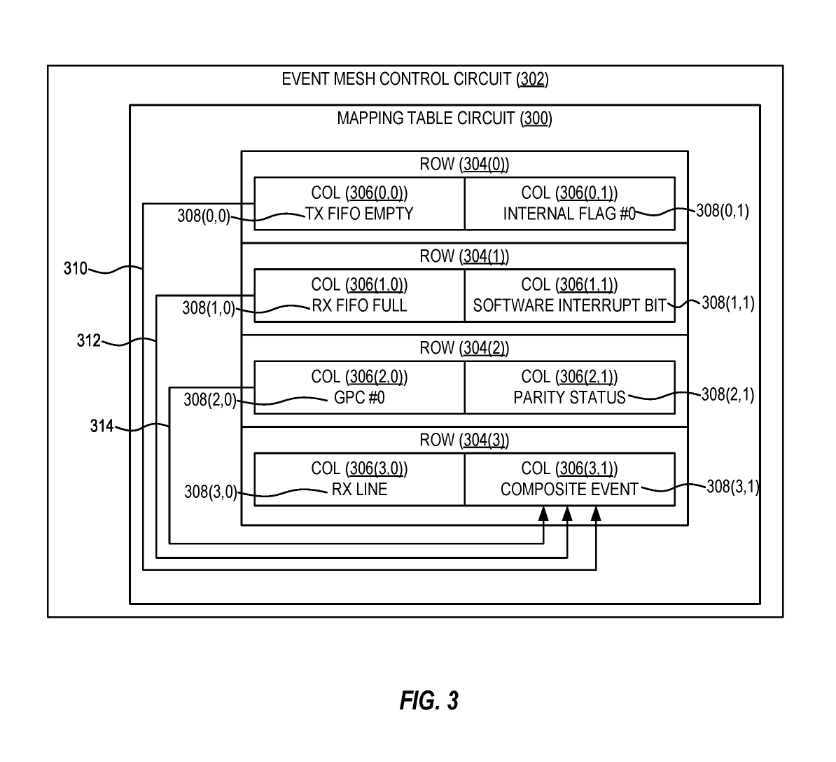

FIG. 3 illustrates the contents of a mapping table circuit 300 of an exemplary event mesh control circuit 302 that corresponds in functionality to the event mesh control circuit 102 of FIGS. 1 and 2. In FIG. 3, the mapping table circuit 300 of the event mesh control circuit 302 provides four (4) rows 304(0)-304(3) that include corresponding columns 306(0,0)-306(0,1), 306(1,0)-306(1,1), 306(2,0)-306(2,1), and 306(3,0)-306(3,1). The columns 306(0,0)-306(3,1) store corresponding event indicators 308(0,0)-308(3,1), each of which indicates a last known status or update of an associated event. In the example of FIG. 3, the event indicator 308(0,0) corresponds to the event “TX FIFO EMPTY” (i.e., an event indicating that the TX FIFO queue 108 of FIG. 1 is empty) while the event indicator 308(0,1) corresponds to a state of “INTERNAL FLAG #0.” Similarly, the event indicator 308(1,0) is associated with the event “RX FIFO FULL” (i.e., an event indicating whether the RX FIFO queue 110 of FIG. 1 is full), the event indicator 308(1,1) is associated with a state of “SOFTWARE INTERRUPT BIT,” the event indicator 308(2,0) is associated with a state of “GPC [general purpose counter] #0,” the event indicator 308(2,1) is associated with the event “PARITY STATUS,” and the event indicator 308(3,0) is associated with the event “RX LINE.” Each of the event indicators 308(0,0)-308(3,0) is updated automatically by the event mesh control circuit 302 as events are received from a microcontroller (such as the events 124(0)-124(N) of the microcontroller 104 of FIG. 1). The event indicator 308(3,1) represents a “COMPOSITE EVENT” that is generated based on an aggregation of the event indicators 308(0,0), 308(1,0), and 308(2,0), as indicated by arrows 310, 312, and 314, respectively. For example, in some aspects, the value of the event indicator 308(3,1) may be set by an aggregation circuit such as the aggregation circuit 212 of FIG. 2 by evaluating the following expression:

(TX FIFO EMPTY!=0) & (RX FIFO FULL!=1) & (GPC #0!=0).

It is to be understood that some aspects may provide that the event indicators 308(0,0), 308(1,0), and 308(2,0) are evaluated in a different manner to determine the value to be stored by the event indicator 308(3,1) as a composite event.

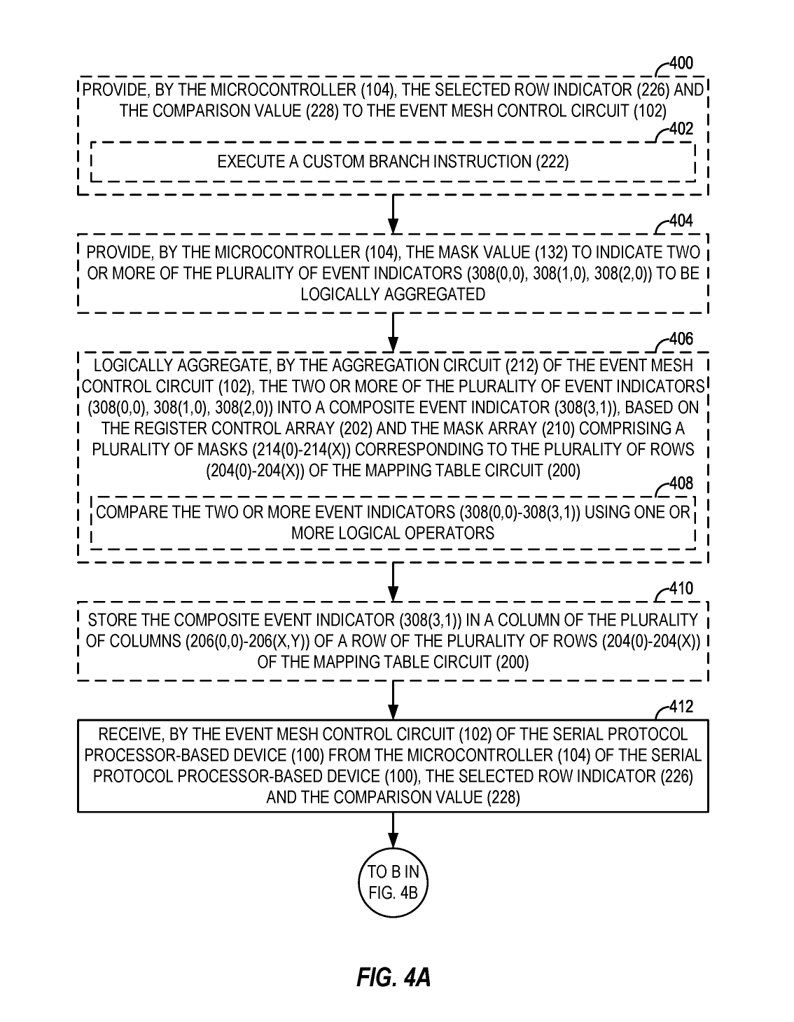

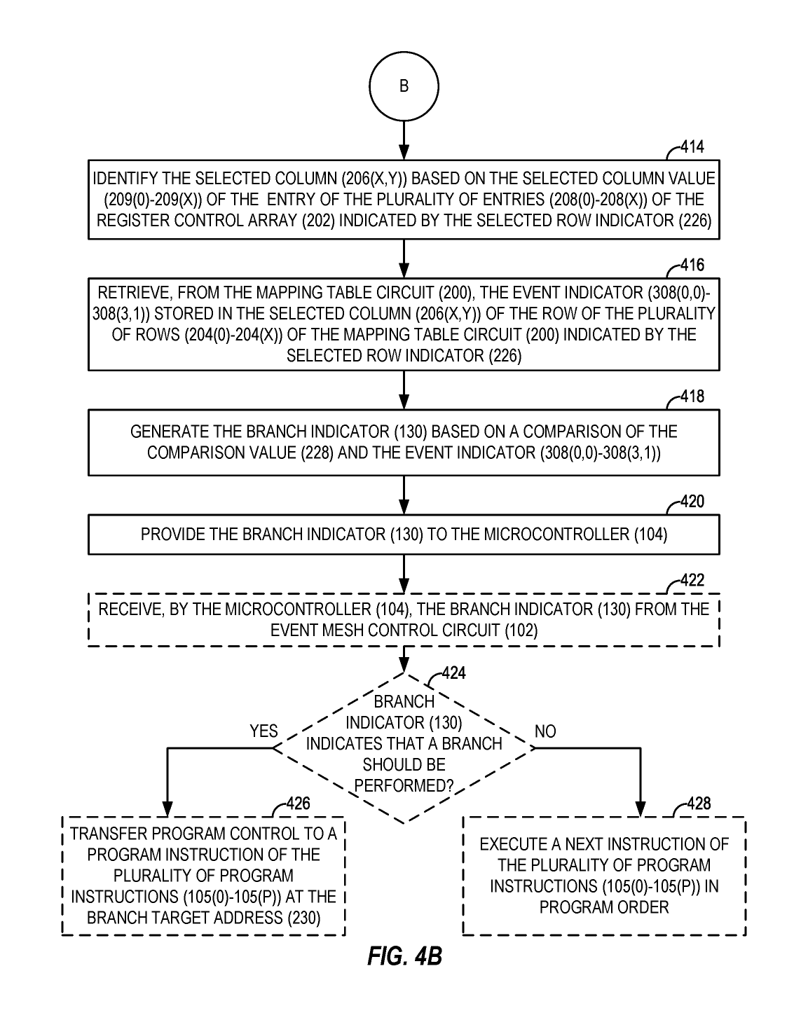

To illustrate exemplary operations for supporting event-based branching by the serial protocol processor-based device 100 of FIG. 1, FIGS. 4A and 4B are provided. For the sake of clarity, elements of FIGS. 1-3 are referenced in describing FIGS. 4A and 4B. Operations in FIG. 4A begin with the microcontroller 104 in some aspects providing the selected row indicator 226 and the comparison value 228 to the event mesh control circuit 102 (block 400). Some aspects may provide that operations of block 400 for providing the selected row indicator 226 and the comparison value 228 may comprise executing the custom branch instruction 222 (block 402). In this regard, the microcontroller 104 may be referred to herein as “a means for executing a custom branch instruction comprising a branch opcode, the selected row indicator, the comparison value, and the branch target address.”

In some aspects, the microcontroller 104 may also provide the mask value 132 to the event mesh control circuit 102 to indicate the two or more of a plurality of event indicators, such as the event indicators 308(0,0), 308(1,0), 308(2,0), to be logically aggregated (block 404). Accordingly, the microcontroller 104 may be referred to herein as “a means for providing a mask value to indicate the two or more of the plurality of event indicators to be logically aggregated.” The aggregation circuit 212 may then logically aggregate the two or more of the plurality of event indicators 308(0,0), 308(1,0), 308(2,0) into the composite event indicator 308(3,1), based on the register control array 202 and the mask array 210 comprising the plurality of masks 214(0)-214(X) corresponding to the plurality of rows 204(0)-204(X) of the mapping table circuit 200 (block 406). The aggregation circuit 212 thus may be referred to herein as “a means for logically aggregating two or more of the plurality of event indicators into a composite event indicator, based on the register control array and a mask array comprising a plurality of masks corresponding to the plurality of rows of the mapping table circuit.” In some aspects, operations of block 406 for logically aggregating the two or more of the plurality of event indicators 308(0,0), 308(1,0), 308(2,0) into the composite event indicator 308(3,1) may comprise comparing the two or more of the plurality of event indicators 308(0,0)-308(3,1) using one or more logical operators (block 408). In this regard, the aggregation circuit 212 may be referred to herein as “a means for comparing the two or more of the plurality of event indicators using one or more logical operators.” The aggregation circuit 212 in such aspects then stores the composite event indicator 308(3,1) in a column of the plurality of columns 206(0,0)-206(X,Y) of a row of the plurality of rows 204(0)-204(X) of the mapping table circuit 200 (block 410). Accordingly, the aggregation circuit 212 may be referred to herein as “a means for storing the composite event indicator in a column of the plurality of columns of a row of the plurality of rows of the mapping table circuit.”

The event mesh control circuit 102 next receives, from the microcontroller 104 of the serial protocol processor-based device 100, the selected row indicator 226 and the comparison value 228 (block 412). In this regard, the event mesh control circuit 102 may be referred to herein as “a means for receiving a selected row indicator and a comparison value.” Processing then resumes at block 414 of FIG. 4B.

Referring now to FIG. 4B, the event mesh control circuit 102 identifies the selected column 206(X,Y) based on the selected column value 209(0)-209(X) of the entry of the plurality of entries 208(0)-208(X) of the register control array 202 indicated by the selected row indicator 226 (block 414). Accordingly, the event mesh control circuit 102 may be referred to herein as “a means for identifying a selected column of a mapping table circuit based on a selected column value of an entry of a plurality of entries of a register control array indicated by the selected row indicator.” The event mesh control circuit 102 retrieves, from the mapping table circuit 200, the event indicator 308(0,0)-308(3,1) stored in the selected column 206(X,Y) of the row of the plurality of rows 204(0)-204(X) of the mapping table circuit 200 indicated by the selected row indicator 226 (block 416). The event mesh control circuit 102 thus may be referred to herein as “a means for retrieving, from the mapping table circuit, an event indicator stored in the selected column of a row of the plurality of rows of the mapping table circuit indicated by the selected row indicator.” The event mesh control circuit 102 then generates the branch indicator 130 based on a comparison of the comparison value 228 and the event indicator 308(0,0)-308(3,1) (block 418). In this regard, the event mesh control circuit 102 may be referred to herein as “a means for generating a branch indicator based on a comparison of the comparison value and the event indicator.” Finally, the event mesh control circuit 102 provides the branch indicator 130 to the microcontroller 104 (block 420).

In some aspects, the microcontroller 104 next receives the branch indicator 130 from the event mesh control circuit 102 (block 422). The microcontroller 104 then determines whether the branch indicator 130 indicates that a branch should be performed (block 424). In this regard, the microcontroller 104 may be referred to herein as “a means for determining whether the branch indicator indicates that a branch should be performed.” If the microcontroller 104 determines at decision block 424 that the branch indicator 130 indicates that a branch should be performed, then the microcontroller 104 transfers program control to a program instruction of the plurality of program instructions 105(0)-105(P) at the branch target address 230 (block 426). Accordingly, the microcontroller 104 may be referred to herein as “a means for transferring program control to a program instruction at the branch target address, responsive to the branch indicator indicating that the branch should be performed.” However, if the microcontroller 104 determines at decision block 424 that the branch indicator 130 indicates that a branch should not be performed, then the microcontroller 104 executes a next instruction of the plurality of program instructions 105(0)-105(P) in program order (block 428). The microcontroller 104 thus may be referred to herein as “a means for executing a next instruction in program order, responsive to the branch indicator indicating that the branch should not be performed.”

Event-based branching in serial protocol processor-based devices according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

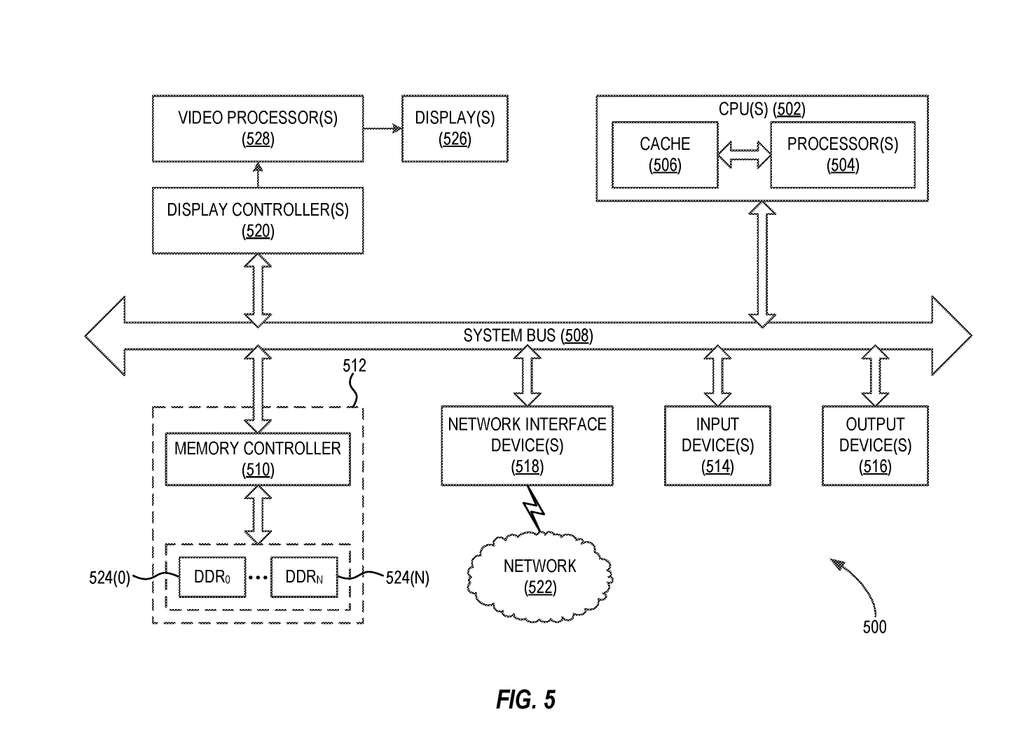

In this regard, FIG. 5 illustrates an example of a processor-based system 500 that may include the serial protocol processor-based device 100 illustrated in FIG. 1. The processor-based system 500 includes one or more CPUs 502, each including one or more processors 504. The CPU(s) 502 may have cache memory 506 coupled to the processor(s) 504 for rapid access to temporarily stored data, and in some aspects may correspond to the serial protocol processor-based device 100 of FIG. 1. The CPU(s) 502 is coupled to a system bus 508 and can intercouple master and slave devices included in the processor-based system 500. As is well known, the CPU(s) 502 communicates with these other devices by exchanging address, control, and data information over the system bus 508. For example, the CPU(s) 502 can communicate bus transaction requests to a memory controller 510 as an example of a slave device.

Other master and slave devices can be connected to the system bus 508. As illustrated in FIG. 5, these devices can include a memory system 512, one or more input devices 514, one or more output devices 516, one or more network interface devices 518, and one or more display controllers 520, as examples. The input device(s) 514 can include any type of input device, including but not limited to input keys, switches, voice processors, etc. The output device(s) 516 can include any type of output device, including, but not limited to, audio, video, other visual indicators, etc. The network interface device(s) 518 can be any devices configured to allow exchange of data to and from a network 522. The network 522 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 518 can be configured to support any type of communications protocol desired. The memory system 512 can include one or more memory units 524(0)-524(N).

The CPU(s) 502 may also be configured to access the display controller(s) 520 over the system bus 508 to control information sent to one or more displays 526. The display controller(s) 520 sends information to the display(s) 526 to be displayed via one or more video processors 528, which process the information to be displayed into a format suitable for the display(s) 526. The display(s) 526 can include any type of display, including, but not limited to, a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microprocessor, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A serial protocol processor-based device supporting event-based branching, comprising:
a microcontroller configured to execute a plurality of program instructions; and
an event mesh control circuit communicatively coupled to the microcontroller, the event mesh control circuit comprising:
a mapping table circuit comprising a plurality of rows, each row of the plurality of rows comprising a plurality of columns storing a corresponding plurality of event indicators; and
a register control array comprising a plurality of entries corresponding to the plurality of rows of the mapping table circuit, each entry of the plurality of entries storing a selected column value indicating a selected column of the plurality of columns of a corresponding row of the plurality of rows; and
the event mesh control circuit configured to:
receive, from the microcontroller, a selected row indicator and a comparison value;
identify a selected column based on a selected column value of an entry of the plurality of entries of the register control array indicated by the selected row indicator;
retrieve, from the mapping table circuit, an event indicator stored in the selected column of a row of the plurality of rows indicated by the selected row indicator; and
generate a branch indicator based on a comparison of the comparison value and the event indicator.

2. The serial protocol processor-based device of claim 1, wherein the microcontroller is further configured to:
provide the selected row indicator and the comparison value to the event mesh control circuit;
receive, from the event mesh control circuit, the branch indicator;
determine whether the branch indicator indicates that a branch should be performed; and
responsive to the branch indicator indicating that the branch should be performed, transfer program control to a program instruction of the plurality of program instructions at a branch target address.

3. The serial protocol processor-based device of claim 1, wherein the microcontroller is further configured to, responsive to the branch indicator indicating that a branch should not be performed, execute a next instruction of the plurality of program instructions in program order.

4. The serial protocol processor-based device of claim 2, wherein:
the microcontroller is further configured to execute a custom branch instruction comprising a branch opcode, the selected row indicator, the comparison value, and the branch target address; and
the microcontroller is configured to provide the selected row indicator and the comparison value from the executed custom branch instruction to the event mesh control circuit.

5. The serial protocol processor-based device of claim 1, wherein the event mesh control circuit further comprises:
a mask array comprising a plurality of masks corresponding to the plurality of rows of the mapping table circuit; and
an aggregation circuit configured to:
logically aggregate two or more of the plurality of event indicators into a composite event indicator, based on the register control array and the mask array; and
store the composite event indicator in a column of the plurality of columns of a row of the plurality of rows of the mapping table circuit.

6. The serial protocol processor-based device of claim 5, wherein the aggregation circuit is configured to logically aggregate the two or more of the plurality of event indicators into the composite event indicator by comparing the two or more of the plurality of event indicators using one or more logical operators.

7. The serial protocol processor-based device of claim 5, wherein the microcontroller is further configured to provide a mask value to indicate the two or more of the plurality of event indicators to be logically aggregated.

8. The serial protocol processor-based device of claim 1 integrated into an integrated circuit (IC).

9. The serial protocol processor-based device of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

10. A method for supporting event-based branching, comprising:
receiving, by an event mesh control circuit of a serial protocol processor-based device from a microcontroller of the serial protocol processor-based device, a selected row indicator and a comparison value, wherein the event mesh control circuit comprises:
a mapping table circuit comprising a plurality of rows, each row of the plurality of rows comprising a plurality of columns storing a corresponding plurality of event indicators; and
a register control array comprising a plurality of entries corresponding to the plurality of rows of the mapping table circuit, each entry of the plurality of entries storing a selected column value indicating a selected column of the plurality of columns of a corresponding row of the plurality of rows;
identifying a selected column based on a selected column value of an entry of the plurality of entries of the register control array indicated by the selected row indicator;
retrieving, from the mapping table circuit, an event indicator stored in the selected column of a row of the plurality of rows of the mapping table circuit indicated by the selected row indicator; and
generating a branch indicator based on a comparison of the comparison value and the event indicator.

11. The method of claim 10, further comprising:
providing, by the microcontroller, the selected row indicator and the comparison value to the event mesh control circuit;
receiving, by the microcontroller, the branch indicator from the event mesh control circuit;
determining, by the microcontroller, whether the branch indicator indicates that a branch should be performed; and
responsive to the branch indicator indicating that the branch should be performed, transferring program control to a program instruction of a plurality of program instructions at a branch target address.

12. The method of claim 11, further comprising, responsive to the branch indicator indicating that the branch should not be performed, executing a next instruction of the plurality of program instructions in program order.

13. The method of claim 11, further comprising:
executing, by the microcontroller, a custom branch instruction comprising a branch opcode, the selected row indicator, the comparison value, and the branch target address;
wherein providing the selected row indicator and the comparison value to the event mesh control circuit comprises providing the selected row indicator and the comparison value from the executed custom branch instruction to the event mesh control circuit.

14. The method of claim 10, further comprising:
logically aggregating, by an aggregation circuit of the event mesh control circuit, two or more of the plurality of event indicators into a composite event indicator, based on the register control array and a mask array comprising a plurality of masks corresponding to the plurality of rows of the mapping table circuit; and
storing the composite event indicator in a column of the plurality of columns of a row of the plurality of rows of the mapping table circuit.

15. The method of claim 14, wherein logically aggregating the two or more of the plurality of event indicators into the composite event indicator comprises comparing the two or more of the plurality of event indicators using one or more logical operators.

16. The method of claim 14, further comprising providing, by the microcontroller, a mask value to indicate the two or more of the plurality of event indicators to be logically aggregated.

17. A serial protocol processor-based device for supporting event-based branching, comprising:
a means for receiving a selected row indicator and a comparison value;
a means for identifying a selected column of a mapping table circuit based on a selected column value of an entry of a plurality of entries of a register control array indicated by the selected row indicator, wherein:
the mapping table circuit comprises a plurality of rows, each row of the plurality of rows comprising a plurality of columns storing a corresponding plurality of event indicators; and
the register control array comprises a plurality of entries corresponding to the plurality of rows of the mapping table circuit, each entry of the plurality of entries storing a selected column value indicating a selected column of the plurality of columns of a corresponding row of the plurality of rows;
a means for retrieving, from the mapping table circuit, an event indicator stored in the selected column of a row of the plurality of rows of the mapping table circuit indicated by the selected row indicator; and
a means for generating a branch indicator based on a comparison of the comparison value and the event indicator.

18. The serial protocol processor-based device of claim 17, further comprising:
a means for determining whether the branch indicator indicates that a branch should be performed;
a means for transferring program control to a program instruction at a branch target address, responsive to the branch indicator indicating that the branch should be performed; and
a means for executing a next instruction in program order, responsive to the branch indicator indicating that the branch should not be performed.

19. The serial protocol processor-based device of claim 18, further comprising a means for executing a custom branch instruction comprising a branch opcode, the selected row indicator, the comparison value, and the branch target address.

20. The serial protocol processor-based device of claim 17, further comprising:
a means for logically aggregating two or more of the plurality of event indicators into a composite event indicator, based on the register control array and a mask array comprising a plurality of masks corresponding to the plurality of rows of the mapping table circuit; and
a means for storing the composite event indicator in a column of the plurality of columns of a row of the plurality of rows of the mapping table circuit.

21. The serial protocol processor-based device of claim 20, wherein the means for logically aggregating the two or more of the plurality of event indicators into the composite event indicator comprises a means for comparing the two or more of the plurality of event indicators using one or more logical operators.

22. The serial protocol processor-based device of claim 20, further comprising a means for providing a mask value to indicate the two or more of the plurality of event indicators to be logically aggregated.
